(19) United States
(12) Patent Application Publication
(10) Pub. No.: US 2009/0271325 A1
(43) Pub. Date: Oct. 29, 2009

(54) TRADING SYSTEM AND METHOD

(75) Inventor: Brian Wilson, London (GB)

Correspondence Address: KNOBBE MARTENS OLSON & BEAR LLP, 2040 MAIN STREET, FOURTEENTH FLOOR, IRVINE, CA, 92614, US

(73) Assignee: EASYSCREEN PLC, London (GB)

(21) Appl. No.: 11/718,329

(22) PCT Filed: Jan. 28, 2005
(86) PCT No.: PCT/GB05/00305

§ 371 Date: Jun. 25, 2009

(30) Foreign Application Priority Data
Oct. 29, 2004 (GB) 0424089.1

(51) Int. Cl. G06Q 40/00

(52) U.S. Cl. 705/36 R

(57) ABSTRACT

A system for managing risk in a trading environment, the system comprising at least one trading portfolio, wherein the trading portfolio comprises a plurality of trading elements and wherein the system further comprises: means for obtaining data relating to trading elements in the trading environment; means for calculating the value of a risk factor for the trading portfolio based on the data received for the trading elements in the trading portfolio; and means for receiving an order for the trading portfolio, wherein the order specifies a trading element; and means for calculating an expected value of the risk factor for the trading portfolio based on the data received for the trading elements in the trading portfolio and the data received for the trading element specified in the order.

The present invention relates to the field of trading systems and, in particular, to the field of trading systems in a financial environment.

Electronic trading systems, which may operate in conjunction with a trading floor or as a distributed system, for example over the internet, are used to trade a wide variety of assets, including shares, commodities, options, futures and currencies.

As the use of such trading systems increases, however, it is becoming more difficult to track and manage the trades that pass through the system and to ensure that large losses are not accrued by a trader. It is also difficult for trading systems to maintain the speed of trading that can be achieved in other environments, for example on a trading floor. Using a slower system may be detrimental, since it may mean that deals are lost or reduced in value as the market moves before the trade can be completed.

The present invention aims to ameliorate some of the problems associated with managing risks in a trading system.

According to one aspect, there is provided a system for managing risk in a trading environment, the system comprising at least one trading portfolio, wherein the trading portfolio comprises a plurality of trading elements and wherein the system further comprises:
means for obtaining data relating to trading elements in the trading environment;
means for calculating the value of a risk factor for the trading portfolio based on the data received for the trading elements in the trading portfolio;
means for receiving an order for the trading portfolio, wherein the order specifies a trading element; and
means for calculating an expected value of the risk factor for the trading portfolio based on the data received for the trading elements in the trading portfolio and the data received for the trading element specified in the order.

Calculating an expected risk factor on receipt of an order from a trading portfolio may enable the system to manage risk within the portfolio before an order is sent to the exchange. Hence the system may advantageously be able to take preemptive action in relation to the trading portfolio, before the order is placed.

In a preferred embodiment, the expected value of the risk factor is calculated based on pre-stored information for use in calculating the risk factor, the pre-stored information being calculated and stored based on the risk factor prior to receipt of the order. Preparing and storing information on which to base the calculation of the risk factor in advance may allow the system to calculate the value of the risk factor and the expected value of the risk factor more quickly during trading within the portfolio. This may advantageously assist in obtaining real-time values and expected values of the risk factor in some embodiments. Hence, in some embodiments, the risk of proposed trades ordered by the trader may be assessed quickly and the risk associated with the portfolio may be managed in real time before orders are placed at the exchange without significantly reducing the speed at which orders can be placed and, hence, without significantly impeding the ability of the trader to trade in a quickly-changing market. The pre-stored information may include information relating to existing filled or unfilled trading elements in the trading portfolio or data relating to the trading portfolio that is substantially constant. Alternatively or additionally, the information may include the last value of the risk factor that was calculated for the portfolio.

Preferably, the system further comprises means for storing data generated in calculating the value of the risk factor. For example, a cache memory may be used to store data. Data in the cache may be stored indefinitely, overwritten by further data and/or backed up to a persistent storage device.

In a preferred embodiment, the expected value of the risk factor may be calculated based further on the stored data. As described above, this may enable the system to calculate the expected value quickly, preferably to enable the proposed order to be placed (if it is cleared) before the market changes.

Preferably, the system further comprises means for comparing the expected value of the risk factor to a predefined maximum value for the risk factor and means for placing the order in the trading environment if the expected value of the risk factor is lower than the predefined maximum value for the risk factor. Hence the system can verify that the order will not cause the risk factor to exceed a maximum value before enabling the order to be placed. This may protect both the trader and the trading system from entering into high-risk situations.

Preferably, the system further comprises means for comparing the expected value of the risk factor to a predefined maximum value for the risk factor and means for refusing the order if the expected value of the risk factor is higher than the predefined maximum value for the risk factor. Hence traders may be prevented from placing orders that would increase the risk factor above a maximum value.

In one embodiment, a first expected value of the risk factor may be calculated and the first expected value of the risk factor may be compared to a predefined maximum value for the risk factor for the trading portfolio to determine whether the first expected value of the risk factor falls within a predefined range around the maximum value of the risk factor. For example, the predefined range around the maximum value may be around 10% of the maximum value, but any other predefined range may be selected as appropriate.

Obtaining a first estimation of the risk factor may be used to determine whether further calculations are necessary. If the expected value of the risk factor is outside the range around the maximum value, the order may be passed to the exchange or refused without further, more complex, calculations being required. This may increase the speed and efficiency of passing orders to the exchange and may reduce the processing required in determining whether each order is permissible.

If the first expected value of the risk factor falls outside the predefined range, the order is preferably placed in the trading environment if the first expected value of the risk factor is lower than the maximum value of the risk factor.

Preferably, if the first expected value of the risk factor falls outside the predefined range, the order is refused if the first expected value of the risk factor is higher than the maximum value of the risk factor.

In one embodiment, the expected value of the risk factor may based on at least one of: profit and loss data, margin, position, outright clip size and spread clip size. In particular, the first expected value of the risk factor may be based on one of the parameters listed. This may provide an efficient method of obtaining a first estimate or approximation of the risk factor. In some embodiments, the risk factor may be based indirectly on the factors listed.

If the first expected value of the risk factor falls within a predefined range around the maximum value of the risk factor, at least one further expected value of the risk factor may be calculated and the order is placed or refused based on the at least one further expected value of the risk factor. Hence further, more accurate calculations of the risk factor may be performed as required to determine whether an order should be permitted if the risk factor is close to the maximum value. A series of calculations may be performed, for example according to a predefined method or algorithm for determining a risk factor, such as the SPAN or TIMS method. Hence the calculation of the risk factor may be performed to a number of different depths as required to determine whether the order is allowable. Intermediate positions or data may be cached to assist in further calculations.

In one embodiment, the at least one further expected value of the risk factor is calculated based on at least one step in the process of performing a SPAN calculation for the trading portfolio. SPAN calculations are based on the Standard Portfolio Analysis of Risk system developed by the Chicago Mercantile Exchange. The SPAN calculation method is known in the art and is normally used to determine a risk factor for a portfolio of orders placed on the market, for example at the end of a day's trading.

In one embodiment, the value of the risk factor or the expected value of the risk factor is calculated based on performing a correlation between trading elements in the trading portfolio. For example, a trading element, such as an option to buy in three months time may be correlated against a further trading element, against current market prices or movements, or against a known pattern of past behaviour for that type of trading element. For example, if you have an option to buy a commodity in December, the risk may be based on a correlation with a seasonal variation in price of that commodity (for example, the knowledge that the price of that commodity usually rises in December). This may allow exchange-based strategy orders to be taken into account in the risk calculation.

In one embodiment, performing the correlation comprises performing correlation between different types of trading elements in the trading portfolio. For example, if a portfolio includes both options and futures in the same commodity, then the correlation of these elements may enable the risk factor to be reduced, since holding both options and futures in a commodity decreases a portfolio's exposure to that commodity. This technique may enable a more accurate estimation of the risk to be performed, rather than adding separate margins for each trading element.

In one embodiment, performing the correlation alternatively or additionally comprises performing the correlation between two trading elements of the same type in the trading portfolio. For example, correlating two options of related commodities.

That is, inter- or intra- commodity correlation may be performed.

In one embodiment, performing the correlation comprises obtaining a measure of volatility for at least one trading element. This may be done using correlation techniques or volatility data may be obtained or derived from market data.

Preferably, the trading elements in the trading portfolio include existing filled and existing unfilled trading elements. That is, the elements may include orders that have been filled at the exchange and unfilled, working orders.

Further preferably, the risk factor may be calculated based a worst case analysis of the unfilled trading elements.

The worst case analysis may be performed based on at least one of:
the current sell value of each trading element;
the current buy value of each trading element;
the volatility of each trading element;
a measure of the correlation between elements in the trading portfolio.
In one embodiment, the volatility of each trading element may be determined based on the volatility of the trading element during the preceding trading period.
In one embodiment, the data received for the trading elements may include at least one of:
   profit and loss data;
   margin;
   position;
   outright clip size;
   spread clip size.

Preferably, the system further comprises means for calculating SPAN data for the trading elements based on the data received for the trading elements.

In an alternative embodiment, the system may further comprise means for receiving SPAN data for the trading elements. For example, the SPAN data for the trading elements may be obtained from the exchanges.

In one embodiment, the value of the risk factor may be calculated based on at least one of:
profit and loss data;
margin;
position;
outright clip size;
spread clip size.

In one embodiment, the value of the risk factor may additionally or alternatively be calculated based on SPAN data for the trading elements.

In a highly preferred embodiment, the system further comprises means for placing the order in the trading environment if the expected value of the risk factor is lower than the current value of the risk factor. Hence a risk-reducing order may be placed even if a portfolio has a risk factor close to the maximum limit or above the maximum limit. This may allow a trader to recover from a high-risk situation. A fast analysis of the risk factor, or of the order being placed, may be performed to determine whether the order is risk-reducing. This may increase the efficiency of the system since, for a risk-reducing order, it may not be necessary to perform a full calculation of the expected value of the risk factor before placing the order. This may increase the speed at which risk-reducing orders may be placed on the market. A method of determining whether an order is risk-reducing or risk-increasing may be to compare and correlate orders within the trading portfolio, for example to determine which orders are covered or balanced and which orders are not covered or are open. An example of a risk-reducing order may be an order that closes a position or a future-type order for which a corresponding option-type order already exists in the portfolio.

In one embodiment, the value of the risk factor comprises a monetary value. The value of the risk factor may comprise a monetary value in the currency of the trading portfolio.

The value of the risk factor may comprise a margin for the trading portfolio. For example, the margin may comprise a clearing margin for the trading portfolio. This may reduce the processing required at the ‘End of Day’ for a market.

The data relating to the trading elements may be received periodically or quasi-continuously. For example, the current ask and bid prices for trading elements may be obtained regularly from the exchanges. In an alternative embodiment, the data relating to the trading elements may be received only on request from the risk management system.

In one embodiment, the trading portfolio may comprise a plurality of trading accounts, each trading account comprising at least one trading element. For example, the plurality of accounts may comprise accounts associated with a single trader. Hence the risk factor may be a factor for a group of accounts, for example all accounts traded by a particular trader or for a particular client.

Preferably, the value of the risk factor may be recalculated at a regular predetermined interval. This may allow the system to maintain an up-to-date value for the risk factor for each portfolio despite changes in the market.

The predetermined interval may comprise around 5 minutes. Alternatively, the predetermined interval may comprise around 1 second. The interval may be different for different trading portfolios and it may be possible to configure the interval individually for each trading portfolio or group of trading portfolios. This may allow system resources to be concentrated on the most active trading portfolios. Any suitable interval for recalculating the risk factor may be used.

The means for obtaining data may comprise means for communicating with external trading systems to obtain values of trade parameters associated with the trading elements. External trading systems may include systems associated with exchanges, such as shares, commodities, options, futures or currency exchanges.

The trading parameters may include at least one of:
the current sell value of the trading element;
the current buy value of the trading element;
the volatility of the trading element;
profit and loss data;
margin;
position;
outright clip size;
spread clip size;
the current volume of the trading element in the market.
The trading elements may comprise trading elements having types comprising at least one of:
   shares;
   commodities;
   options;
   futures;
   currencies.

The system may further comprise means for comparing the expected value of the risk factor to a predefined alert value for the risk factor and means for generating an alert message if the expected value of the risk factor is greater than the predefined alert value for the risk factor. This may allow the system to alert a trader, manager or administrator when a trading portfolio is approaching its maximum value. Action may then be taken, for example to sell some of the higher-risk assets or to place future orders only for low-risk assets.

Preferably, at least one of the predefined maximum value and the predefined alert value for the risk factor is defined by a portfolio administrator. The maximum and alert values may be defined individually for each trading portfolio or different groups or types of portfolios may be assigned common values. Alternatively, the maximum and alert values may be defined automatically by the system based on, for example, the liquidity or balance of the portfolio or the types of assets being traded. The maximum and alert values may be constant or may vary, for example with market conditions or in dependence on the performance of the portfolio.

Embodiments of the system preferably further comprise a management interface, wherein an administrator can access information relating to the trading portfolio, and wherein the interface comprises at least one of means for:
placing orders in the trading environment for the trading portfolio;
setting maximum and alert values for the risk factor for the trading portfolio;
monitoring the trades performed within the trading portfolio;
monitoring the value of the risk factor for the trading portfolio;
refusing orders for the trading portfolio;
receiving warning messages generated by the system in response to variations in the value of the risk factor.

This may allow a manager or administrator to set and change parameters for the trading portfolio, to trade on behalf of a trader and to review the status of trading portfolios, including receiving warning messages.

According to a further aspect, there is provided a management interface for a system for managing risk in a trading environment, the system comprising a plurality of trading portfolios, wherein each trading portfolio comprises a plurality of trading elements and wherein the management interface comprises:
means for receiving data relating to each trading portfolio, the data including the value of a risk factor associated with each trading portfolio;
means for obtaining an expected value of the risk factor associated with a trading portfolio based on an order for a trading element submitted by the trading portfolio;
means for displaying an alert signal if the expected value of the risk factor is greater than a predefined maximum value for the risk factor for the trading portfolio.

Hence the interface may alert a manager or an administrator if the order would cause a risk factor for the portfolio to exceed a predetermined amount. This may allow the administrator to take action, if necessary, before the order is submitted to the exchange.

The interface may further comprise means for setting the maximum value for the risk factor for one or more trading portfolios. The maximum value for the risk factor may be the value of the risk factor above which the trader for the trading portfolio is not permitted to trade.

Preferably, the interface further comprises means for setting an alert value for the risk factor for one or more trading portfolios.

The interface may further comprise means for displaying an alert signal if the expected value of the risk factor for a trading portfolio is greater than the alert value for the trading portfolio.

The management interface preferably further comprising means for preventing a submitted order for a trading element from being placed in the trading environment.

In one embodiment, the interface may further comprise means for placing a submitted order for a trading element into the trading environment.

Preferably, the management interface further comprises means for displaying information associated with a plurality of trading portfolios. This may allow an administrator to monitor and/or compare trading portfolios. Preferably the means for displaying is configurable by the administrator.

In one embodiment, the information associated with the trading portfolios may comprise at least one of:
account name;
account balance;
profit and loss;
margin utilisation;
net liquidity;
net equity;
number of order rejections.

The management interface may further comprise means for placing an order into the trading environment for a selected trading portfolio. This may allow an administrator to trade on behalf of a trading portfolio, for example if the trader is prevented from trading since the risk factor is above the maximum limit, or may allow the administrator to update the portfolio, for example if an order is input by telephone.

According to a further aspect, there is provided a system for managing risk in a trading environment, the system comprising at least one trading portfolio, wherein the trading portfolio comprises a plurality of trading elements and wherein the system further comprises:
means for obtaining data relating to the trading elements in the trading portfolio;
means for calculating the value of a risk factor associated with the trading portfolio based on the data received;
means for periodically updating the risk factor associated with the trading portfolio;
means for calculating an end of day position for a trading portfolio.

Calculating the end of day position for a portfolio may enable the exchange or clearing house to close the account more efficiently at the end of day or on close of the exchange. Periodically calculating the end of day position may further allow the system to ensure that sufficient margin is retained in the account to cover the clearing house margin and hence avoid clearing calls to the accounts.

Preferably, the system further comprises means for closing a trading session on an exchange for a trading portfolio and means for supplying data relating to the end of day position for the trading portfolio. Hence the end of day position may be calculated for the trading portfolio, or a section of the portfolio and the data may be supplied directly to the exchange. This may be more efficient than calculating the end of day position at the exchange and may expedite the process of closing the trading session, hence minimising the disruption in trading caused to the trader.

Preferably, the calculation of the value of the risk factor includes the value of the margin charged for each trading element. For example, the margin charged by a clearing house.

The risk factor may be calculated based on SPAN data for the trading elements.

The means for calculating the value of a risk factor preferably comprises means for calculating a risk value for each trading element in the trading portfolio and means for combining the risk values for each trading element to form a risk factor for the trading portfolio.

Preferably, the end of day position may be calculated based on at least one of:
the profit and loss for the trading portfolio;
the liquidity for the trading portfolio.

In one embodiment, the system may further comprise means for receiving an order for a trading element on the exchange whilst closing the trading session, means for calculating an expected value for the risk factor incorporating the order for the trading element and means for accepting or rejecting the order for the trading element based on the expected value for the risk factor. Hence orders for an exchange wherein the session is closing may still be received and may be accepted or rejected based on the calculated expected risk factor, even if the orders can not be sent to the exchange at that time.

According to a further aspect, there is provided a system for calculating the value of a risk factor for a trading portfolio, the trading portfolio comprising a plurality of trading elements in a trading environment, the system comprising:
means for obtaining data relating to the trading elements in the trading environment;
means for calculating a first value of the risk factor for the trading portfolio based on the data received for the trading elements in the trading portfolio using at least one step in a predefined method for calculating the value of a risk factor;
means for comparing the first value of the risk factor to a predefined maximum value of the risk factor;
if the first value of the risk factor is greater than the predefined maximum value of the risk factor and falls within a predefined range above the predefined maximum value of the risk factor, means for calculating at least one further value of the risk factor using further steps in a predefined method for calculating the value of a risk factor;
means for caching the first value and the further values of the risk factor in a memory.

As described above calculating and caching risk factors, or information associated with risk factors, may increase the efficiency of the calculation of the expected value of the risk factor and may enable orders to be placed in the markets more quickly, reducing the risk of the markets having moved by the time the order is placed and reducing the processing that is required to be undertaken by the system.

In one embodiment, the predefined method for calculating the value of a risk factor comprises the SPAN method.

The trading portfolio may comprise filled and unfilled orders. In this case, the value of the risk factor may be calculated based on a worst-case analysis of the unfilled orders.

Preferably, the trading portfolio comprises at least one pre-trade order. Pre-trade orders may also be known as pre-execution orders, since the orders have not yet been submitted to the markets.

Preferably, the value of the risk factor is used to determine whether the pre-trade order can be placed in the trading environment.

According to a further aspect, there is provided a method of calculating the value of a risk factor for a trading portfolio, the trading portfolio comprising a plurality of trading elements in a trading environment comprising filled and unfilled orders, the method comprising:
obtaining data relating to the trading elements in the trading environment;
calculating a first value of the risk factor for the trading portfolio based on the data received for the trading elements in the trading portfolio using at least one step in a predefined method for calculating the value of a risk factor;
comparing the first value of the risk factor to a predefined maximum value of the risk factor;
if the first value of the risk factor is greater than the predefined maximum value of the risk factor and falls within a predefined range above the predefined maximum value of the risk factor, calculating at least one further value of the risk factor using further steps in a predefined method for calculating the value of a risk factor;
caching the first value and the further values of the risk factor in a memory.

According to a further aspect, there is provided a method for managing risk for at least one trading portfolio in a trading environment, wherein the trading portfolio comprises a plurality of trading elements and wherein the method comprises:
obtaining data relating to trading elements in the trading environment;
calculating the value of a risk factor for the trading portfolio based on the data received for the trading elements in the trading portfolio;
receiving an order for the trading portfolio, wherein the order specifies a trading element; and
calculating an expected value of the risk factor for the trading portfolio based on the data received for the trading elements in the trading portfolio and the data received for the trading element specified in the order.

According to a further aspect, there is provided a method of managing risk for at least one trading portfolio in a trading environment, wherein the trading portfolio comprises a plurality of trading elements and wherein the method comprises:
obtaining data relating to the trading elements in the trading portfolio;
calculating the value of a risk factor associated with the trading portfolio based on the data received;
periodically updating the risk factor associated with the trading portfolio;
calculating an end of day position for a trading portfolio.

Preferred features and advantages of the method aspects correspond to the preferred features and advantages of the system aspects set out above. Features of one aspect may be applied to other aspects.

According to further aspects, computer program or computer program product for implementing a method according to any of the method aspects or the preferred features may be provided.

Embodiments of the invention will now be described in more detail with reference to the drawings in which:

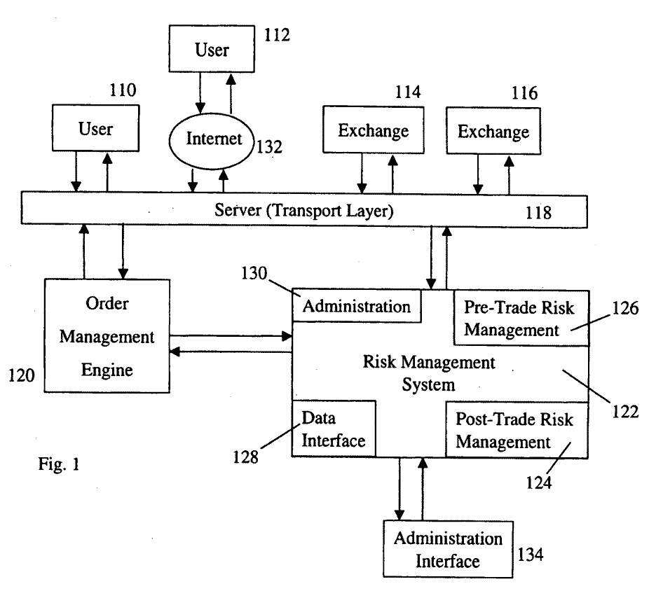

FIG. 1 is a schematic overview of one embodiment of a trading system into which aspects of the system described herein may be integrated;

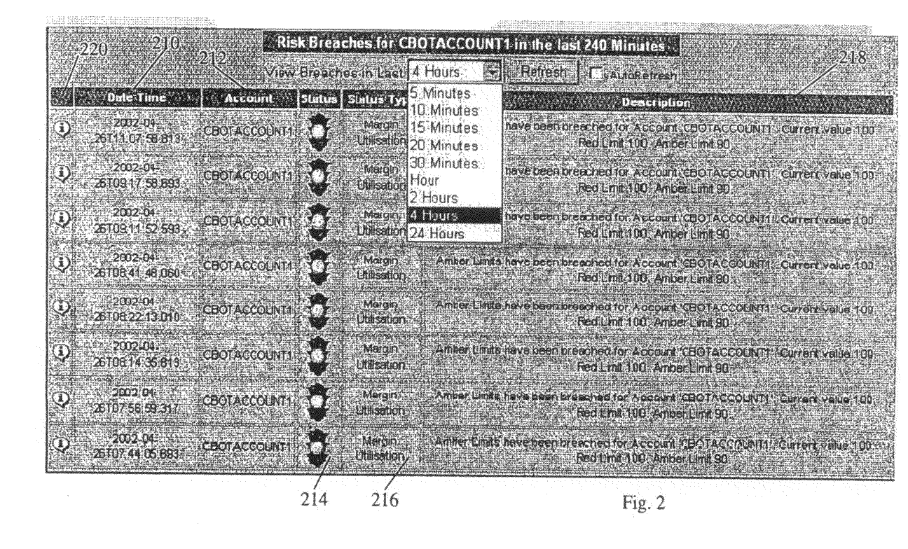

FIG. 2 illustrates a view of one embodiment of an administration interface for a system;

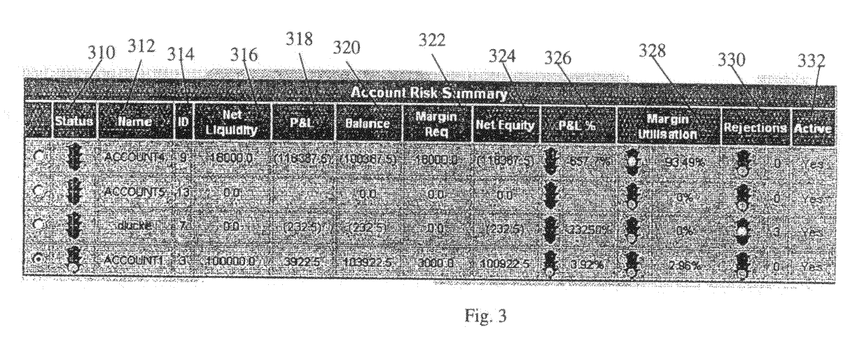

FIG. 3 illustrates a further view of an administration interface illustrating a summary of the risks relating to a number of accounts;

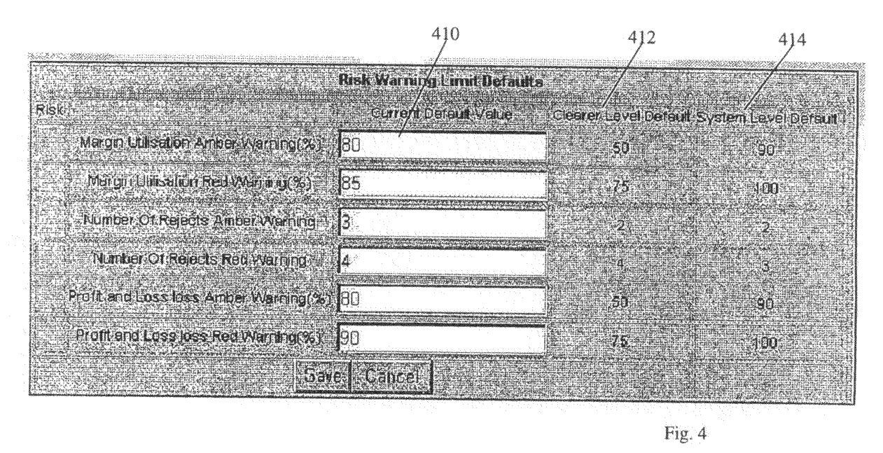

FIG. 4 illustrates one embodiment of an interface that may be used with the administration interface or with a user interface illustrating a summary of the status of a plurality of accounts;

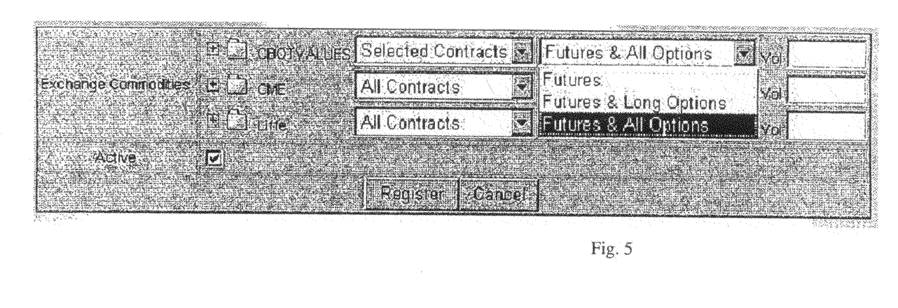

FIG. 5 illustrates a further aspect of one embodiment of the administration interface;

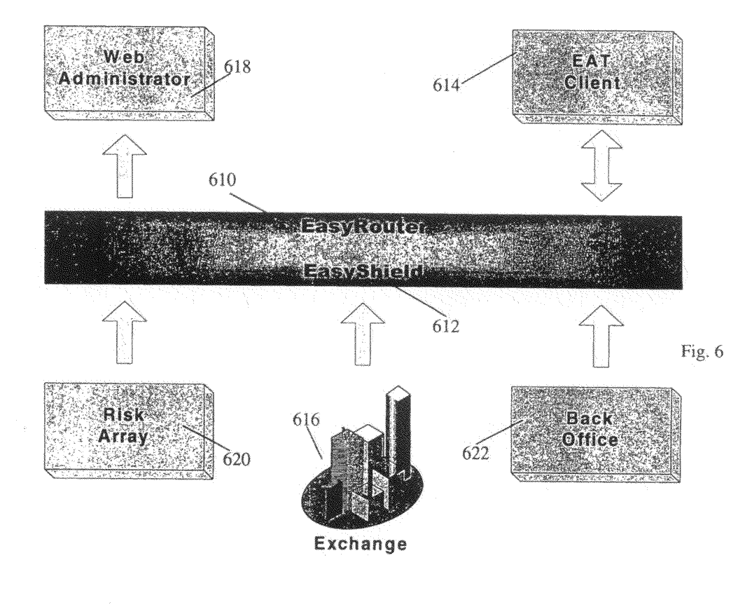

FIG. 6 illustrates in overview a further embodiment of a system as described herein;

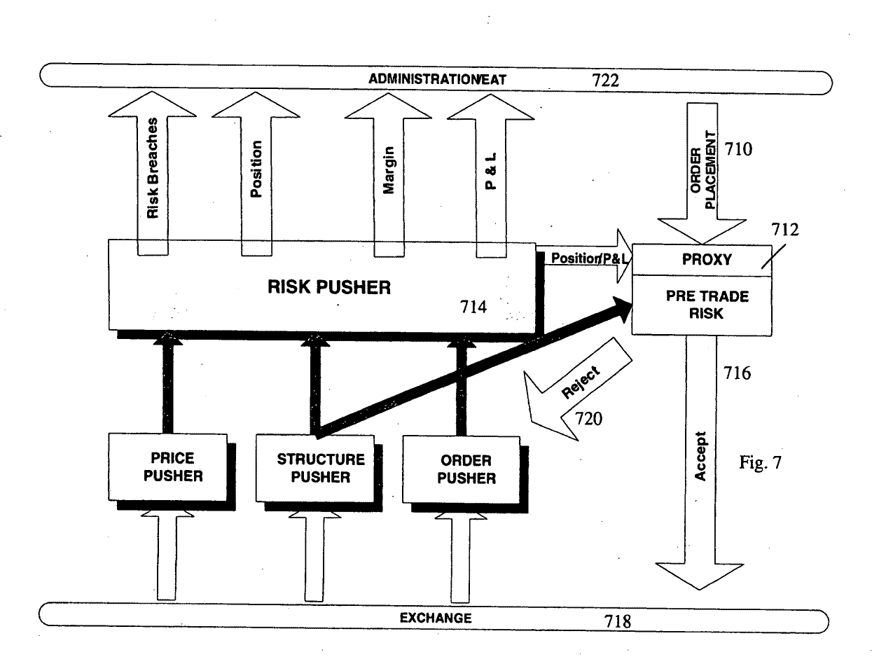

FIG. 7 illustrates one embodiment of the architecture of a system as described herein;

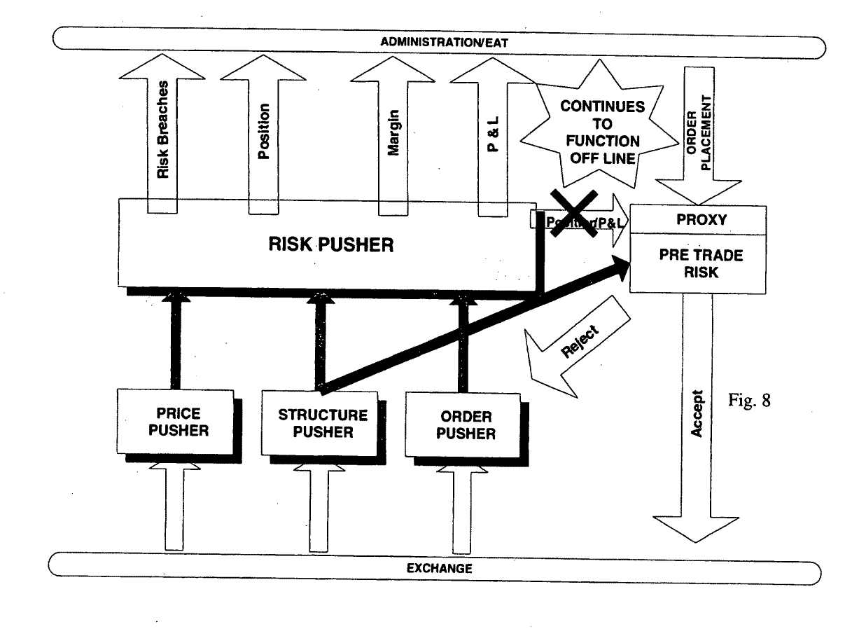

FIG. 8 illustrates schematically the operation of the proxy and order placement system if the risk pusher is offline according to one embodiment.

One embodiment of a trading system that may incorporate aspects of the invention described herein will be described with reference to FIG. 1. This description is not intended to be limiting in any way and it will be clear to one skilled in the art that fewer or additional components may be provided and that components may be provided separately or may be integrated.

Users 110, 112 may be connected to the trading system via a server or transport layer 118. The user may be connected to the server 118 directly, or may connect via the Internet 132 or another network, for example via a private network. The user 110, 112 may run a user trading interface to allow the user to interface with the trading system, for example to place trading orders, view trading data and transfer funds. Two users are illustrated in FIG. 1 but it will be clear to one skilled in the art that a large number of user devices may be connected to the system.

The server 118 may further interface with one or more exchanges 114, 116, preferably via private secure connections. The exchanges may include stock exchanges, currency exchanges or commodity or futures exchanges. Two exchanges are shown in FIG. 1 but a large number of exchanges may connect to the server.

The users 110, 112 and exchanges 114, 116 may connect via the server 118 to an order management engine 120. The order management engine 120 may enable the users 110, 112 to interface with the exchanges 114, 116 to perform actions such as placing trade orders, monitoring existing filled and unfilled orders and cancelling orders. The order management engine 120 may further enable a user 110 to view the current status of their portfolio and the current value of their holdings on the exchanges.

A further component of the embodiment illustrated in FIG. 1 is the risk management system 122. In alternative embodiments, the risk management system may be integrated with other components, such as the order management engine. The risk management system 122 of the present embodiment interfaces with the users 110, 112 and the exchanges 114, 116 via the server 118 and interfaces with the order management engine directly, although in some embodiments, the risk management system 122 may also be connected to the order engine 120 via the server 118.

The risk management system 122 of the present embodiment includes components such as the data interface 128, which may obtain or receive information from the exchanges 114, 116 and/or the users 110, 112. For example, the data interface 128 may obtain details of the current market price of assets held by the users and the volatility in the prices of those assets.

The risk management system 122 further comprises a post-trade risk management component 124 and a pre-trade risk management component 126, although the two components may be provided as a single integrated component. The post-trade risk management component 124 may be used to calculate the value of a risk factor for the existing portfolio of each user or of selected users. As described in more detail below, a risk factor may be calculated for each asset in the portfolio of a user and the risk factors may be combined to produce an overall risk factor for the portfolio. The risk factor may be calculated based on factors including: the type of asset, the volatility of the price in the asset and the volume of the asset held in the portfolio. The post-trade risk factor is preferably calculated based on both the filled orders in the portfolio and the unfilled orders. For example, if the user has placed an order to buy 100 shares at or below a defined price and only 50 shares have been bought, one component of the risk factor will take into account the filled order for the 50 shares that have been bought and a second component of the risk factor will take into account the unfilled order for the 50 shares that have not yet been bought, preferably on a worst-case basis.

The pre-trade risk management component 126 may further be provided to calculate a risk factor for user portfolios that include components for trade orders that have not yet been placed. For example, a user may request the system to place an order to buy a defined volume of a particular asset, such as a commodity, at or below a defined price. The pre-trade risk management component 126 obtains information relating to the asset, for example its current price and the volatility of the price, and calculates a risk value for the proposed trade. This risk value is combined with the current post-trade risk value for the user to produce a pre-trade risk value. As described in more detail below, if the pre-trade risk value exceeds a predefined limit, the proposed trade may be blocked or may have to be approved before being placed by the order management engine 120. Calculating a pre-trade risk value may advantageously enable the system to determine what the risk value for the user will be before the order is placed and hence prevent orders being placed that will cause the user to exceed a predefined risk value limit.

The administration component 130 of the risk management system 122 may obtain and store data relating to trades undertaken by the users 110, 112. For example, the administration component 130 may include data relating to the current assets of the user portfolios and historical data relating to trades previously undertaken by a user. The administration component 130 may be provided as a separate component from the risk management system 122.

The system is preferably further provided with an administration interface 134. The administration interface 134 may be used by a system administrator to perform tasks such as adding or removing users and/or exchanges from the system. The administration interface 134 preferably further allows an administrator to set predefined risk value limits for each user and to monitor risk levels. For example, the risk value for a trader on a trading floor handling a large portfolio may be set at a higher level than a risk value for a small private trader trading over the Internet.

As described in more detail below, in a preferred embodiment, more than one risk value limit may be set for each user. A maximum hard-limit may be set, above which the user may be restricted from placing at least some types of order. In addition, one or more warning limits may be set. The administration interface 134 may monitor the risk values for each user and, when the post-trade or pre-trade risk values for the portfolio of a user reach a warning limit, the interface 134 may generate alert messages, which may be sent to an administrator or displayed on the interface. This may allow the administrator to monitor user portfolios and take action if necessary or appropriate.

If the risk values for a user portfolio exceed the defined limit, the administration interface 134 may allow an administrator to take action, for example to block trades, trade on behalf of users or permit only trades that reduce the risk values. The administration interface 134 may further enable an administrator to perform more fundamental changes to the system, for example to change how the pre-trade and post-trade risk values are calculated.

FIG. 6 illustrates in overview a further embodiment of a system as described herein. A router (EasyRouter) 610 and a risk management system (EasyShield) 612 may provide an interface between the clients 614 and the exchanges 616 and may implement aspects of the system described herein. A web administration interface 618, a risk array 620 and an interface to back office systems 622 may further be provided.

Further features of one embodiment of a risk management system for a trading system will now be described. The description is not intended to be limiting in any way and features and components of the system described may be provided separately or in combination.

As described above, embodiments of the present system may enable pre-trade risk control over multiple accounts and across multiple exchanges, globally amalgamating tradable product positions and margins for equities, bonds and derivatives.

The system is preferably designed as a front-end independent system. That is, it may be implemented in conjunction with a wide range of existing user front-end systems. In addition, the system may integrate into existing back-end systems to import information such as margin rates, overnight trade positions, overnight cash balances and foreign exchange rates.

In a preferred embodiment, the system may offer a number of different levels of risk management. For example, the risk management may relate to profit and loss alone, cash alone or cash and position, or the risk management may be turned off for a particular portfolio.

Warning parameter levels are preferably selectable by trading level, for example account, clearer and system, by frequency of breach attempts, by a percentage of the margin or by a percentage of the profit and loss.

FIG. 2 illustrates a view of one embodiment of an administration interface for a system. The page of the interface that is illustrated shows all risk breaches for account ‘CBOTACCOUNT1’ in the last 4 hours, or 240 minutes. The administrator can view details of each breach, including the date and time of the breach 210, the account name 212, the status of the breach 214, for example whether the user breached the amber or red limits and the type of breach 216. Additional information about the breach may be provided in the Description column 218 and further information may be obtained by clicking on the information icon at the left hand side of the screen 220. The administrator may select an alternative time period, as illustrated, or may refresh the data or select the tick box to specify that the data should be auto-refreshed.

FIG. 3 illustrates a further view of an administration interface illustrating a summary of the risks relating to a number of accounts. This account summary may be displayed on an administration interface or on an interface for a trader who is managing a number of different accounts, in this case four accounts. The overall status 310 of each account is shown on the left hand side. In this case, the overall status of the first three accounts is ‘red’, which may mean that the accounts are prevented from trading, and the status of the fourth account is ‘green’, which may mean that the user is permitted to trade from that account. Each account is identified by an account name 312 and identifier 314. Financial details of each account are then provided. In this case, the financial details include the Net Liquidity 316, the Profit & Loss 318, the Balance 320, the Margin Required 322 and the Net Equity 324 for the account, but the values illustrated may be defined by the user or administrator. Negative amounts for the values may be highlighted in red and/or shown in brackets, as illustrated in FIG. 3.

Financial indicators may be calculated by the system from the financial details and illustrated in the summary. For example, the Profit & Loss as a percentage of the Net Liquidity may be shown 326 together with the Margin Utilisation 328 and the number of Rejected Trades 330. Each of the financial indicators may be provided with a indication of whether the indicator is breaching a predefined limit, for example in the form of a red, amber or green traffic light. The system administrator may define how may of the indicators can be in the amber or red status before the user is prevented from trading using that account.

FIG. 4 illustrates one embodiment of an interface that may be used with the administration interface to enable an administrator to define ‘red’ and ‘amber’ limits for a particular user, a portion of the system or the whole system. The limits may be set to a specific value 410 by the administrator or may revert to the clearer level default 412 or system level default 414 limits. Limits that may be set using the interface shown include:
Margin Utilisation Amber Warning (%)
Margin Utilisation Red Warning (%)
Number of Rejects Amber Warning
Number of Rejects Red Warning
Profit and Loss Amber Warning (%)
Profit and Loss Red Warning (%)

FIG. 5 illustrates a further aspect of one embodiment of the administration interface which may allow an administrator to set up features and properties of user accounts and/or exchanges, for example to set up the account rights at an exchange level.

The limits of the risk values set by the administrator may also be known as margins for the account and, as illustrated above, a single account may have different margins relating to different aspects of trading. Further details of different margins and how they may be calculated for a particular user account according to one embodiment are provided below.

Features that may be provided in a preferred embodiment of the system described herein may include one or more of:
Multi-Currency aware
P&L, Margin, Position, Clip Size, Price Limits
Theoretical option valuation for Profit & Loss (P&L) (preferably including all Black/Scholes calculation variants)
Volatility auto-implied from previous days settlements
P&L Implies prices for back months from front month settlement variance
Fill Leg information synthetically generated from Market Data if not supplied by the exchange (for P&L purposes only)
Admin Tool support for viewing Accounts P&L
Pre-Order Placement risk checks on P&L, Margin (Exposure), Position and Outright/Spread Clip Size (both set an exchange/contract level)
Real Time SPAN(Liffe,eCBOT,CME etc) and TIMS (Eurex) margining both pre and post trade, as described in more detail below
Worst Case Analysis of working and filled orders including both outright and spread positions/orders (using what if? type scenarios).
a Cross contract margin offsetting (for example, risk may be reduced by offsetting one contract against another)
Fast Risk Managed Pre-Trade Order Placement
Risk reducing orders allowed
Breach Limits/Alerts (criteria may include one or more of: Margin Utilization, P&L Loss, Price Limits, Breach attempts, Net Equity)
Automatic daily upload of SPAN/TIMS raw files containing margin rules and risk arrays from the clearing websites
Net Liquidity automatically increased/decreased by selling/buying options
Position delta for inter month options spreads
Admin Tool support showing full breakdown of margin calculations (e.g. spread rebates)
All risk changes via the Admin Tool are dynamically applied to the risk system.
Commission is included in the calculations
Margin Factor & Intraday allowable credit
P&L takes account of market modes (e.g. P&L locked at last trade in a post-trade auction)
Pre-Trade performance was a key goal—there are various architectural and algorithmic features to improve throughput and latency
Scaleable to thousands of accounts across multiple markets & instruments
Back Office integration
Hierarchical risk managed groups and supervisors
Centralized Risk management and administration by remote browser
Supports Gearing/Margin Factor/Commission Adjustment.

Calculation of the risk value or margin may be performed using the Chicago Mercantile Exchange's Standard Portfolio Analysis of Risk (“SPAN”) system or the OCC's Theoretical Intermarket Margining System (TIMS). For options and futures, the SPAN or TIMS margining is preferably performed in real-time to provide an up to date estimate for the risk inherent in a mixed portfolio of contracts. Inter-month spreading may be performed using a tiering system, for example different margins may be calculated for September 4/December 4 spreads to those calculated for September 4/December 5 spreads.

The system preferably imports SPAN/TIMS files from the FTP sites automatically and estimates the worst case SPAN portfolio risk based on working and filled orders real time. What If? scenarios may be used to take into account the impact of working orders. Inter Month spreading may be provided based on the SPAN tiering system and cross commodity spreading may further be provide. Fungibility may further be supported (e.g. cross exchanges/electronic vs Pit).

An example of a worst case analysis calculation is provided below. For example, for a scenario where the trader is trading Long 2 Sep, the margins for each of the trades are added to provide a worst case margin.

| | | |
|---|---|---|
| +2 Working Sep | Outright $2000 | |
| −1 Working Dec | Outright $3000 | Spread $500 |

| Scenarios | Margin |
|---|---|
| 1. O fills | $0 |
| 2. Short 1 Dec | $3000 |
| 3. Long 1 Sept | $2000 |
| 4. Long 2 Sept | $4000 Worst Case |
| 5. 1 Sep Dec Spread | $500 |
| 6. 1 Sep Dec Spread + | $2500 |
| 1 Sep Outright | |

Embodiments of the system preferably provide full support for all SPAN spread types post trade (e.g. butterfly/condor positions created with outrights are spotted and given the appropriate rebate). These may include:
Cross Commodity spreading (e.g. 10 Yr Note vs. Eurodollar (Tier 1))
Cross Exchange spreading (e.g. CBOT 2 Year T-Note vs. CME Eurodollar)
Risk Reducing orders allowed (e.g. by creating a butterfly from a calendar spread position, closing an outright position, etc)
Breach limit alerts
Supports margining on all exchange traded strategy types (including Option strategies and Volatility Trades)
Working order “cherry picking” algorithm for fast margin calculation on complex portfolios containing >100 working spread orders.
Automatic Rollover using exchange settlement prices

Using SPAN portfolio management as described herein to determine a measure of the risk may provide a value for the worst case risk for 24 hours. The Net Liquidity of an account may be automatically increased/decreased by selling/buying options. In one embodiment, a premium margin may be calculated:
a Long Option Premium Value may be used to offset other margin requirements
a Short Option MTM Premium may be calculated real time for short option credits

A variation margin may further be calculated as the P&L MTM real time for Futures. A Short Options charge may be added to cover theoretical risk on OTM options and the position delta for inter month options spreads may be taken into account.

The example below provides an example of calculations for a portfolio of the net liquidity, the margin, the premium margin and the net equity a trader operates the portfolio.

| | Net Liq | Margin | PM | Net Equity |
|---|---|---|---|---|
| | 1000 | 0 | 0 | 1000 |
| Buy Call @ 500 | 500 | −500 | +500 | 500 |
| Sell Put @ 200 | 700 | −800 | +300 | 200 |
| Put falls in value to 100 | 700 | −800 | +400 | 300 |

Profit & Loss values for the portfolio may also be calculated in real time in embodiments of the system. If there are no prices in a back month, the system may imply data from the nearest month (settlement variance). The system is preferably configured to ensure that it will always find a price (e.g. best ask, last trade, implied, settlement).

A theoretical value may be determined for options (if it differs by X % from Best Bid/Ask) and real time Black & Scholes calculation variants may be used (dependant on contract type).

In a preferred embodiment, the volatility may be auto-implied from previous days settlement or a value for the volatility may be imported. Values for the Expected Dividends/Interest Rates may also be imported. In a preferred embodiment, new models can be easily added to the system.

As described in more detail below, closing positions are preferably always allowed providing they are risk reducing, which may mean that the impact of the order will not increase the worst case margin. For example:
Closing down one leg of a filled spread is risk increasing
Covered write (i.e. placing a Short Call to cover a Long Future position) is risk reducing
Delta neutral exchange supported calendar spread where one leg is closing does not increase risk.

Exchange Traded Strategies may be supported in the present system and values of a risk factor may take into account the strategies. Fill Leg information may be synthetically generated from Market Data if not supplied. The system preferably supports all strategy types (including Option strategies and Volatility Trades) and supports all SPAN marginable strategies (e.g. Spreads, Condors, Butterflies). A working order “cherry picking” algorithm may be used in the system.

As described above, an administrative interface or administrative console may be provided, which may allow an administrator to monitor account activity and to set instrument or position limits on accounts and manage orders.

### Monitoring Accounts

In a preferred embodiment, accounts should be marked to market throughout the day at intervals of 5 minutes or less (preferably around 1 second), and accounts that exceed pre-defined risk parameters should be reported via alerts and a real-time update to various reporting screens. The amount of time between analyses of each account may be constrained by the number of accounts in the system and the processing speed of the hardware.

The reporting screens may include the Master Monitor, which notifies the administrator of any potential limit violations via reports which are updated in real-time. Reports that may be notified to the administrator via the Master Monitor interface or otherwise may include:
“x” attempted trades by this trader have been rejected today. This trigger may be reset back to zero once the administrator acknowledges the notification.
Total account equity available for margin is less than x percent of required initial margin. The start-of-day Total Equity number will be the Total Equity number downloaded from Memphis/GMI (i.e. Ending Cash Balance +/−Futures Open Trade Equity). Initial margin is defined as the amount of money required by the exchange to establish a position.
The daily PAL shows a loss of “x” percent of the beginning net liquidating value of the account. Net Liquidating Value=Total Equity+Securities on Deposit +/−Net Option Value. Administrator can set this value at 100% to receive notification of a negative account value.
Price Limit Amber Warning (%) and Price Limit Red Warning (%).on placement of a limit order, EAT will reject the order if the price entered is greater than the settlement price+red limit percentage amount (of the settlement price). EAT will present a warning confirmation dialog box to the trader on limit orders if the price entered is greater than the settlement price+amber limit percentage amount.

The screen may further be configured to display 3 different states to show whether an account is trading within its normal assigned risk parameters:
Level 1—Normal (this may be represented as a green traffic light in some embodiments)
Level 2—Trader has lost “x1” percent of beginning net liquidating value of the account, or the account has less than “y1” percent of required initial margin. (this may be represented as an amber traffic light in some embodiments)
Level 3—Trader has lost “x2” percent of beginning net liquidating value of the account (maximum allowable loss limit), or the account has less than “y2” percent of required initial margin (this may be represented as a red traffic light in some embodiments).

In a preferred embodiment, the administrator may have the ability to grant limited administrative rights to other user classes on a subset of accounts. The classes of users may include:
Risk controller—The administrator can grant a user the status of Risk Controller. The administrator can then assign a subset of accounts on which a risk controller can perform administrative functions including: 1) Monitor accounts (risk status). 2) Manage accounts and account limits—including rights to trade on behalf of and set account limits.
Risk Supervisor—The administrator can grant a user the status of Risk Supervisor. The administrator can then assign a subset of accounts on which the risk supervisor is able to monitor risk status.

### Manage Accounts

The administration interface or Account Monitor may further provide easy access to manage accounts. Clicking on an alert in the account monitor may bring up all of an account's positions and provide an interface to allow administrator to perform some of the following risk management functions:
One click calculation of Initial Margin Required for account and Margin Deficit. Margin deficit is the difference between net account equity (Cash or cash equivalents on account+Daily P&L) and Required Initial Margin.
Display last calculated Initial Margin Required and Margin Deficit.
Add or delete a trade to an account without a new order or cancel order command actually being executed on the exchange—or allow administrators to change price or quantity of an existing order. This may allow an administrator to add or amend a trade that did not originate in the system (i.e. phoned in) so that the risk calculation will be accurate for a trader.

View current position and open orders for selected account.

Lock an account so trader can no longer trade account. This may allow the administrator to trade account independent of the trader.
Cancel an open order (or all open orders) for selected account.
Cancel/Replace an open order for selected account.
Buy or sell (futures and options) for selected account.
Customized Alert Message to Trader Screen (real-time or at login if customer is not currently trading) for all traders OR selected trader.
Change the currency conversion rates from those imported from the Memphis currency file.
The administrator can instruct a rerun of End of Day (EOD) for an account or a clearer without marking accounts as inactive or unavailable for trading. The screen displays the current EOD position for confirmation and allows the EOD data/time to be overridden.

An administrator may further be enabled to manage account options and Limits. For example, an administrator may be able to perform one or more of the following functions:
Set tradable Instruments by the account.
Optionally, set futures, short options position limit by instrument/account.
Position limits are effectively separate for Options & Futures (i.e. a position limit will be set against an option & a separate position limit will be set against a future). Note that the margin calculations will create synthetic strategies for short options against futures and give credit for the hedging position.
   In a preferred embodiment, the margin calculation will be the sum of the absolute values of the worst cases for every month of an instrument. For instance:
      Worst case January contract=10
      Worst Case March Contract=10
      Worst Case June Contract=−10
         Total=abs (worst case Jan)+abs (worst case March)+abs (worst case June)=30. No relief is given for spreads.
Set Initial Margin intraday “Day Trader” multiplier level (“Margin Factor”). This multiplier assumes a default value at the time the account is created, but can be modified at the account level.
Set an optional daily loss limit on an account (% of net liquidating value calculated at start of each day). This can be set at 2 different levels (i.e. x percent can generate a level 1 warning, and y percent can generate a level 2 warning). This number is a multiplier and is entered as a percent. This daily loss limit is a percentage of the start of day net liquidating value of an account. These percentages may be used to trigger the alert notification levels as described above.
Change initial margin requirements per instrument
Allow account to trade without any limits or margin checking.
Ability to add “allowable margin credit” at the account level. Administrator can set optional “Credit Expire Date” (valid values are 1_never, 2_today only and 3_date with default of 1_never), which specifies the date where the credit would revert to zero. This can serve 2 functions: 1) Allow trader to trade on credit 2) Add in funds that have been received via wire intraday. In preferred embodiments, there are three options for an account rights at an exchange level:
   1) Trade Futures.
   2) Trade Long Options.
   3) Trade Options and Futures.
NOTE: An account trading “Long Options only” has to be able to close their position regardless. These accounts are only banned from going short.
Clip Size limits may be set by the administrator in the Admin Tool or administration interface at an Exchange & Commodity Level. The Commodity Level settings may override the Exchange set level. Separate clip size limits are set for strategies & outrights. Clip Size checking can be enabled or disabled at an Account level. If the order volume exceeds the Clip Size limit then the order is rejected.
The commission required on a trade can be specified. To make things clear, it may display a message listing the round trip commission (which is double this). The commission may be used to calculate commission on trades at the tradable entity and account level. The Net Equity may be adjusted to take account of the commission paid.

### Margin

The margin is the amount required by the clearing house from its members, and by its members from their customers for opening a position on the market and hence the margin may be closely related to the risk value in embodiments of the present system. The margin is intended to cover outlays that the clearing house may incur in event of default by a clearing member (or those that clearing members may incur in case of default by any of their customers) up to complete liquidation of the positions of the defaulting party.

The performance bond calculation method aims to guarantee market security while reducing the costs for financing operations on the market. The SPAN method is based on the estimation of the overall risk exposure of a portfolio. The margin therefore represents the most unfavourable liquidation value of a portfolio in case of a downturn in the market evolution, calculated for one market day.

The SPAN method considers not only futures contracts and options on futures contracts but also other types of options. It makes a uniform evaluation of all products having the same underlying instrument thus taking an overall view of the portfolio composed of options and futures contracts.

### Risk Arrays

The SPAN method is based on the estimation of the balance liquidation value of a portfolio according to several scenarios anticipating the market's evolution. This data is stored in risk arrays, which are specific to each contract, and updated on a daily basis.
The scenarios used by SPAN consider the following:
   Possible variation of underlying price,
   Possible variation of underlying volatility,
   Impact of time on option price.

The prices of the futures contracts and options contracts of the portfolio vary with changes in these factors. Through these scenarios, SPAN determines the maximum loss sustained by a portfolio from one market day to the next. The clearing house then sets a performance bond amount calculated to cover the buying of the portfolio exhibiting such a loss.

SPAN considers a total of 16 risk scenarios by using a scan range, or fluctuation range of the underlying instrument price and a volatility range defined for each combined commodity. The basic concept used for risk calculation is the combined commodity. This is a set of contracts having the same underlying instrument. The SPAN method calculates the hedge using this concept.

The risk arrays integrate seven price variation possibilities:
No variation,
Price increase or decrease corresponding to 1/3 of the scan range,
Price increase or decrease corresponding to 2/3 of the scan range,
Price increase or decrease corresponding to 3/3 of the scan range.

For each of these price changes, an upward or downward variation in volatility is also considered.

Short option positions which are highly out of the money when reaching expiration represent a specific problem; it is true that, should the underlying instrument vary sharply, these positions could then be in the money. SPAN includes two scenarios to consider this risk, one for the fall in the underlying price, the other for a rise in price corresponding to two scan ranges. However, only a fraction of the total loss thus calculated is considered in the risk arrays.

### Intermonth Spreads (or Calendar Spreads)

SPAN also takes into account reductions in risk due to the presence of opposite positions on different months within the same combined commodity. The use of risk arrays implicitly assumes that price changes across months of a combined commodity are perfectly correlated, but this is not always so. In order to correct this aspect, SPAN proceeds as follows:
The net delta for each month for which a position is held is considered. The long net deltas are added as also the short net deltas. The greatest number of possible spreads is formed. This number is then multiplied by the charge for each spread specified by the clearing house. The resulting amount is added to the amount calculated from the risk arrays (or “scanning risk”).

For instance, in the case of the EURIBOR combined commodity, tiers are defined within the months in order to consider risks specific to a three-year quotation period. A spread within a tier (which for example, groups together the first two months) results in a specific charge, whereas a spread calculated with another tier results in a different charge. A priority table for spread calculation is therefore supplied for this purpose.

### Delivery Month

In the case of some deliverable contracts, an additional risk exposure may arise when the delivery date is close. In order to consider this risk, SPAN adds two charges:
On spread positions including one delivery month,
On straight positions for the delivery month.

### Inter Commodity Spreads

For distinct contracts with close underlying instruments (CAC 40 Future and DJ Euro STOXX Future for example), the price variations may be correlated. Therefore, opposite positions in two different combined commodities can lead to reduce the global risk of the position. A decrease in the margin payable is therefore calculated. For these spreads, SPAN generates a credit expressed as a percentage of the margin called for the commodity group. For simplicity of this calculation, options are converted into their equivalent delta position.

### Short Option Minimum Charge (Short Positions)

In event of a sharp variation of the underlying instrument price, short option positions can lead to considerable losses. SPAN therefore includes an additional step: It calculates a minimum amount (or “performance bond minimum threshold”) called for short positions in each combined commodity. This amount will be called if it is higher than the result obtained in the previous steps.

### Cross Exchange Spreads

Some clearers have SPAN offsets that allow cross exchange margining. For example CME vs CBOT.

The system described herein preferably further includes means for managing implied volatility levels for a theoretical option pricing system. That is, when marking a position to market for calculating the net liquidating value of an account, futures prices may be updated from the last available price provided by the system data feed (for example, Reuters). Option prices may be calculated from the underlying futures price and an implied volatility level that will be provided by the risk manager may be implied using a binomial Black/Scholes algorithm based on the previous day's Settlement Price for the option and underlying future. Option values may be calculated from their theoretical values based on a Black/Scholes calculation. The administrative console will provide the risk manager the ability to change the implied volatility values.

The default volatility value used in the theoretical option valuation calculation may be the implied volatility of the option (using a binomial Black/Scholes algorithm) as calculated by the previous day futures and options settling price.

In some embodiments, the risk manager may be able to override these default implied volatility values manually by resetting them with the admin console or administration interface.

The admin console or administration interface may further provide the ability to reset the volatility value used in the theoretical option value calculation with a single click of the “Current Volatility Snapshot” button for an instrument. This button may be used to calculate the current implied volatility of the at the money option, and sets this value to all of the options in the instrument.

Criteria for allowing or disallowing a trade in embodiments of the system will now be described in more detail. In the event the Risk Management System rejects an order, a message may be sent back to the client with the rejection reason (e.g. “Risk Parameters Exceeded. Please call customer service desk for more information”).

A trade may not be allowed if the account does not have adequate initial margin in the excess equity. Excess equity should be enough to cover the current open position—as well as the worst case scenario from potential fills from open orders that are not yet filled. Net equity may be calculated as:

Net Liquidity (start-of-day from Memphis/GMI)

| | |
|---|---|
| Plus (+) | Securities on Deposit |
| Plus (+) | Allowable Margin Credit |
| Plus (+) | Variation Margin (MTM for futures, equities & FX) |
| Minus (−) | Commission payable on trades |
| Minus (−) | Margin Requirement/Margin Factor + Premium Margin. |
| | Maximum of 0 allowed. |

Initial margin values per instrument may be pulled from an initial margin table. The margin requirement/margin factor value should not be set to 0 for overflow reasons.

If a portion of the total requested trade is risk reducing, adequate initial margin may be needed only for the “Risk-Adding” portion of the trade. For instance, if a trader is short 1 bond, and enters an order to buy 2, he only needs to have sufficient initial margin for a single bond contract as one of the contracts is liquidating a short. Note that this calculation is complex and should take into account the cost of breaking any already rebated spreads.

The worst case margin effect should be calculated for any active orders. This includes the cost of breaking any spreaded positions. An active order is considered risk adding when it increases the worst case position at a commodity level and cannot be spreaded against a fill. Any active orders that are not considered risk adding are free from margin. This means that the margin figure quoted on any portfolio will be the worst case loss (in home currency) that can be made in the next 24 hours (based on historical exchange data). This will include the worst case impact of any active positions should they completely fill or part fill.

A trade is not allowed if it is a risk adding trade, and the daily maximum “loss limit” has been breached and trade rejection was requested in the account profile.

For the purpose of risk management, the system may start with the start of day position as reported by the Memphis Back office in the CEAL file (Customer Equity and Activity List), and assumes that all new positions originated through the system (i.e. were not phoned in). Any orders that were not entered via the system front end, or added via the admin console as described above, will not be included in the risk calculation.

All accounts should be marked to market and analyzed for risk in real time. The futures price will be updated with the last trade price. The Options prices will be calculated using the underlying futures price, and an implied volatility value.

The system may be set up to allow all risk-reducing orders. An order is risk reducing if it is a closing order that does not increase worse case margin at a commodity level. The reason for the closing order condition is that a trader can be −2 short and the worse case margin will not be increased by a +4 buy order (since the worse case margin is 2*unit margin rate in this case). However, the closing position is only +2. In this case the trader will not be allowed to go +2 long if he is a negative equity situation. There is the possibility that a new position trade can be risk reducing as well (such as legging into a spread) this has been discounted in the present embodiment.

Long option positions are allowed provided there is a sufficient excess equity in the account after meeting margin requirements to carry the existing position. For the purpose of this calculation, existing long option premium will not be added into excess equity. A long option may be considered as an asset. For example, if you purchase a call for $1000, at the time you make the purchase you have $1000 worth of something. If the value then goes to $2000—you have $2000 worth of something.

The logic employed here is that a trader essentially purchases this “asset” with money and the gain or loss is not realized in the account until the asset is sold. In the meantime this “asset” cannot be used as collateral to margin futures. Risk is essentially saying that if you want to purchase a long option then you must have the money in your account to do it. If the price goes up or the price goes down—the profit or loss is not realized until the option is sold. In the meantime, the monetary value of the option cannot be used to margin other positions.

The risk calculation should automatically create synthetic strategies for both intra and inter (cross) commodity fills. Rebates for these strategies may be supplied by a SPAN import from for each exchange. The resultant strategy rebate offsets the outright margin cost for fills.

Synthetic calendar spread strategies may be created for active orders against fills. Any remaining active orders can be spreaded against each other.

Filled contracts that are effectively the same (e.g. pit traded vs electronically traded, e-mini vs it's big brother) may be automatically funged. All relevant position and cost is transferred to the parent contract and ratio'd accordingly. If not all position is being transferred then the cost is worked out based on the average price paid for a fill in a multiple of tick size.

In preferred embodiments, risk adding trades are not allowed in the following situations:
The trade would cause the account to exceed one of its preset limits in the requested instrument as described above (count open, but unfilled, orders in this calculation if they are risk adding).
The account is not authorized to trade the requested instrument.
The account does not have sufficient initial margin in excess funds.

Rules relating to closing positions in the present embodiment of the system will now be discussed in more detail.

If closing a position will increase the overall portfolio risk then there must be enough net equity to cover the additional margin risk. This is because closing a position is not necessarily risk reducing (e.g. closing one leg of a synthetic spread).

Filled positions covered by active orders will still be synthetically spreaded post trade.
TE1+1 filled
TE2−1 filled with active (+1)

A synthetic spread of (+1, −1) will be created in this case but the worst case margin will include the costs of breaking this spread should the active position fill.

Closing a synthetically spreaded position will result in the relevant worst case breakage cost deducted from margin (i.e. the amount previously credited to both TEs involved in the spread). If there are multiple separate spreaded positions then the breakage charge should only reflect those spreads that are being actively broken.

An exchange traded spread will be allowed providing the spread is delta neutral and any of its legs are closing positions. Note that the closing position calculation includes any existing covering active orders. The reason for this is that the attempted closure will either completely succeed or completely fail and so the exchange is effectively guaranteeing that delta neutral closing spreads are not risk increasing (since all legs must be filled).

As a further feature of embodiments of the system, active strategies may be margined to take into account the filled spread rebate (if it exists). This is because the worst case is either that nothing changes (i.e. order is cancelled) or that both legs fill creating a new synthetic filled spread (in which case a spread will be created & rebate credited). This is assuming the spread is not a closing spread. If either legs are closing then the relevant filled position is offset.

All forms of exchange traded strategies are supported in preferred embodiments and the risk calculated (including all options strategies). In addition, outright worst case positions that form SPAN supported spreads (e.g. Condors, Butterflies, etc) may use the relevant spreaded rebate.

For P&L purposes, for exchanges that don't support spread leg breakdowns, these will be generated automatically. The spread price of sells are actually reversed (i.e. if I sell a March-June Spread (Selling March at 97.75 and buying June at 97.54) then the spread price is 0.21. If your buys exceed your sells and you are buying then the spread price is +ve, if you are selling it's −ve and vice versa.

| | BUY MAR | SELL JUNE | SPREAD PRICE |
|---|---|---|---|
| BUY: | 97.72 | 97.705 | 0.215 |
| | 97.505 | 97.72 | −0.215 |

| | SELL MAR | BUY JUNE | SPREAD PRICE |
|---|---|---|---|
| SELL: | 97.75 | 97.54 | 0.210 |
| | 97.54 | 97.75 | −0.210 |

Features of the Profit & Loss may include one or more of the following:
All prices may be converted to the correct currency and real price (taking into account tick value & formatted prices).
Any flat positions may be worked out based on the actual loss between the price bought and sold.
Any long positions may be compared against the calculated Best Bid.
Any short positions are compared against the calculated Best Ask.
If a valid Best Bid/Ask/Last Trade or Settlement are received they are stored.
If an invalid price arrives then that price is marked as invalid and not used in calculations.
Note that for options a theoretical value may be used based on the underlying price (which will follow the same rules). The Black/Scholes model is used for this. If a theoretical value cannot be calculated (e.g. cannot imply volatility) then the real price in the market may be used (if it exists) and applied to the calculations below.

The order of priority in obtaining a price is outlined below. If no recent best bid or ask or last trade exists then the price may be implied based on the delta settlement price movement in the front month applied to the settlement price of the back month.

### Calculating a Valid Best Ask:

### Front Month

1) Best Ask (pre-open included)

### 2) Last Trade

### 3) Best Bid

### 3) Settlement

### Not Front Month

1) Best Ask (pre-open included)

### 2) Last Trade

3) Implied Price—Risk Pusher finds the difference between the calculated Best Ask of the front month of the commodity and the front month's settlement price (if these exist). It then adds this to the Settlement Price (if it exists) to generate an implied Best Ask.

### 4) Best Bid

### 5) Settlement Price

6) Front Month Price (a very last resort and will give a more accurate figure than 0)

### Option

1) Best Ask (pre-open included) providing its variance from the Theoretical Value is less than X % (defaults to 15).

### 2) Theoretical Value

### 3) Last Trade

### 4) Best Bid

### 5) Settlement

### Calculating a Valid Best Bid:

### Front Month

1) Best Bid (pre-open included)

### 2) Last Trade

### 3) Best Ask

### 3) Settlement

### Not Front Month

1) Best Bid (pre-open included)

### 2) Last Trade

3) Implied Price—Risk Pusher finds the difference between the calculated Best Bid of the front month of the commodity and the front month's settlement price (if these exist). It then adds this to the Settlement Price (if it exists) to generate an implied Best Bid.

### 4) Best Ask

### 5) Settlement Price

6) Front Month Price (a very last, resort and will give a more accurate figure than 0)

### Option

1) Best Bid (pre-open included) providing its variance from the Theoretical Value is less than X % (defaults to 15).

### 2) Theoretical Value 3) Last Trade

### 4) Best Ask

### 5) Settlement

Embodiments of the system may further take into account gearing, which may allow traders to buy and sell equities by only paying a fixed percentage of the actual price. This may enable traders to gain from price movements, dividends, etc in equities, foreign exchanges without being required to deposit the full cash. Features of this aspect may include one or more of:
At an account level, the Risk Manager can specify the gearing percentage for equities. This may default to 100%.
On receipt of a new working order, this gearing percentage will be applied to the limit price (or current market price in the case of market orders) and used to calculate the gearing margin. For filled orders on an individual TE, the gearing margin will be the average on side trade price*position*the gearing percentage.
Any active orders covering filled positions (i.e. closing orders) may be free of gearing margin.
a Gearing margin may be applied regardless of whether each TE is long or short (e.g. if I sell 1@100 with 50% gearing then it will cost 50).
Variation margin (P&L) may also be applied to geared equities.
Proper pre-trade support will wait for the pre-trade mod to pump orders through Risk Pusher. A 100% gear will be assumed until the order is handled by Risk Pusher and the correct gearing applied.
The Margin Factor may not be applied to the gearing margin.

End Of Day (EOD) Positions—Embodiments of the system may provide automated or manual rollover as described below.

Manual Rollover—Implemented full support for an external EOD feed via Secom/FIX. Risk Pusher automatically rolls over on receipt of an external position message (providing manual EOD has been set). It assumes all EOD positions have been set to 0. It then extracts gross liquidity (& sets uploaded liquidity to this). EOD positions are subsequently updated from the repeating group. An account does not need to be switched off during this process since it will still be risk managed.

Automated Rollover—A process that monitors EOD times for exchanges & settlement prices. Automatically rolls over Tes by locking away P&L at the settlement price and charging commission. The rollover occurs when the exchange has closed & settlement prices are received. Positions held overnight are rolled into any existing EOD positions from previous days & the locked away P&L incremented by the losses for the day. Note that “day” in this instance refers to an exchange trading session. A user trading on more than one exchange will have multiple rollovers during the course of their physical day. If a rollover has never occurred then it assumes that the first one will be at the end of the current trading session. The Net Liquidity is automatically decremented by the locked away P&L, which is also loaded on Risk Pusher start up along with the EOD details.

An option may be provided on the admin tool or the administration interface for Automatic Rollover. The interface may also display locked away P&L at the TE and account level.

The uploaded liquidity preferably does not include the margin for any EOD positions (e.g. if account A is 20 long at the end of the day in a contract with a margin of 20000, the liquidity does not take this into account). That is, accounts preferably get margined at the same rate regardless of how long the positions have been held.

In preferred embodiments, the margin system makes no distinction between initial & maintenance margin.

Preferably, the last rollover time is estimated if we haven't yet rolled over. All assume exchange closing time for HH:MM but the day may cause a problem.

On start up—If there is no settlement price assume “now—24 hours” for the day. If there is a settlement price then assume “settlement price time—24 hours” If we've already rolled over then assume the “last EOD rollover” as the day.

On rollover—Assume “settlement price time” as the day—note we can't assume “now” since we may have not received a settlement price for a few days and want to make sure that when that settlement price comes it does not contradict the EOD. This is primarily assuming that exchange rollover and settlement price receipt occur in the same UTC day. If there are exchanges where settlement prices arrive on a different UTC day from the exchange closing then other defaults for the system may be applied.

In summary, the End of Day (EOD) functionality may provide:

### Automatic Rollover

Locks away P&L at the Settlement Price
Adds Commission for the day

### Manual Rollover

Matches up feed positions with current/previous session fills

This may enable real time 24×7 trading, since users can continue trading while rollover is in progress. Effectively, the system preferably prepares for EOD as trades occur so there is no extra load on the system when EOD occurs

An example of the calculations associated with a position in a day is provided below:

| Start with 10000 | Net Liq | Bid | Ask | Theo | P&L | Net Equity |
|---|---|---|---|---|---|---|
| Buy 1 Opt @500 | 9500 | 450 | 455 | −50 | 9500 | 9500* |
| | 9500 | 600 | 602 | +100 | 9600 | 9500* |
| | 9500 | 900 | 700 | +200 | 9700 | 9500* |
| Buy 1 Fut @3000 | 9500 | 2900 | | +100 | 9600~ | 9400* |

| EOD Rollover | Call settles at 800 (+300) Future settles at 3250 (+250) | | | |
|---|---|---|---|---|
| | 9750** | +300 | 10050~ | 9750* |

*If Excess Long Option MTM Premium cannot be used for purchases.
**Locked away 250 Future P&L
~Assume no margin

Features of the options risk management according to one embodiment will now be described in more detail.

In the present embodiment, both TIMS and SPAN data may be imported on a daily basis to give the theoretical price movements of options. Internally, both SPAN and TIMS based algorithms may be implemented to determine a risk value for each portfolio. Therefore, true portfolio Risk Management may be provided. The system may also give a real time calculation of the same margin figure that the clearing house will apply at the EOD. Some features of embodiments may include one or more of:
If a trader shorts a deep out of the money (OTM) option (put or call) then the margin we were charging on that is minimal (since at the time he shorted it's effectively worthless). Assuming normal market conditions then the counterpart to the trade obviously feels that this will be worth exercising at some point (otherwise why buy?). Therefore, there is a risk that this OTM position will move into the money (ITM), in which case the seller will be left nastily exposed to underlying future movements (with little covering margin). This is especially true when options reach expiry and are more sensitive to sharp swings in the underlying. One feature that may be implemented to get round this is to spot these situations when working out margin and margin them higher accordingly.
It is possible for traders to trade in such a manner that their risk is negligible and therefore the margin charged would be equally minimal. However, the exchange mandates a minimum margin to be charged per lot long or short. Therefore the present system works out the margin, and if less than the minimum margin, it will charge the minimum margin on the worst case fills.
Premium Margin—The Account's Gross Liquidity may be altered in real time to reflect the assets (e.g. options, equities) bought and sold. A new feature, which may be termed ‘Premium Margin’, has been introduced to reflect the gain or loss that these liabilities or assets now represent (depending on whether sold or bought). In a simple case this may be reflected in a margin credit if the account is long and a margin deficit if short, but it depends on at what price the assets were bought and sold and the combination of previous trading prices. This Margin Premium concept although abstract may be used to determine the effect on the overall Estimated Margin Requirement at an account level. This means that a net buyer of options will typically see the margin he is charged for the risk on these options as being minimized, and it may also cope with the net flows of cash involved in spread transactions and short sellers.

FIG. 7 illustrates one embodiment of the architecture of a system as described herein. The system may be implemented as a distributed system and some of the elements shown in FIG. 7 may be implemented in more than one physical component. Alternatively, elements of the system may be combined into a single component. Orders may be placed 710 at a proxy 712 and a pre-trade risk analysis may be performed using position and profit & loss data obtained from the risk pusher 714.

The order may then be accepted 716 and forwarded to the exchange 718 or it may be rejected 720. An administration interface 722 may receive information relating to the portfolios, for example the margin and position of the portfolios.

As illustrated in FIG. 7, the pre-trade risk analysis may be performed at a proxy 712. This may enable the system to scale easily, since one risk analysis element may be provided at each proxy 712. As described in more detail above, tiered calculations may be performed. For example, simple position and/or cash checks (profit & loss, margin etc.) may be performed as a first check and the system may then switch to a full or partial SPAN-based check if the initial checks fail. Providing the pre-trade risk analysis at a proxy may also ensure that orders are risk managed even if the main risk system fails. Preferably, the system is implemented as a second generation system and preferably has no database dependency.

Further technical features of embodiments of the system may include:
The whole risk system may be written in C++ for performance.
Fast Recovery of the system may be performed (helped by the system having a minimal database dependency).
The system may monitor the state of all input feeds (orders, prices & structure) and automatically recovers from the loss of any of these feeds.
The system may be implemented as a multithreaded system with minimal use of critical sections.
Built in price throttling may be provided for P&L/Theo calculations.
Asynchronous database updates may be provided (for history only).
The Pre Trade may be scalable by Proxy as described above. The Risk Pusher may be scalable by clearer.
The Risk Pusher may be designed to stay up 24×7, since updates may be performed dynamically.

FIG. 8 illustrates schematically the operation of the proxy and order placement system if the risk pusher is offline.

In summary, features of embodiments of the system described herein may include one or more of the following:
Restricts access from Exchange level down to Individual Contract
Restricts Order Types to; Futures, Futures & Long Options, Futures and All Options
Pre trade Position and Cash checks prevent a new order from breaching limits
Extra liquidity can be permitted intraday
Long options can be permitted if equity covers
Closing trades permitted, even if cash is inadequate
Reduced margin requirements by offsetting contracts: related futures form virtual calendar
spreads; short options are paired with related futures.
Majority of processing occurs post trade
Maximum speed pre-trade permissioning
Centralised Risk management and administration by remote browser
Theoretical vales for Options Profit & Loss calculation
Scaleable to 10,000+ accounts across multiple markets & instruments
Messaging facility for traders or groups of traders for risk administration
Hierarchical risk managed groups and supervisors
Risk controller can pull/close trades for an individual or group of orders
Risk controller can lock out groups or individual traders
Risk controller can add synthetic orders to fulfill/close trades
Risk controller can alert trader to breaches
Risk controller has total tracking and transparency of any order
Risk controller can increase margin factor for individual accounts
Risk controller can set P&L roll over time
User can alter password
Full history and audit trail for each trade and a login history for users

An example of a calculation of a margin on a worst-case basis is provided below. The example is based on the closing spread analysis that may be done post trade in preparation for quickly spotting breaking positions on (high margin costs) for pre-execution orders to make them faster, but similar calculations incorporating similar assumptions and considerations may be undertaken in a pre-trade situation.

Assume the Unit Margin Rate on Sterling is 325 and on Euribor is 550. Assume a Sterling December 3 March 4 spread has been created (with a credit for each spread of 205). Also assume we get an 80% rebate on a cross commodity Sterling December 3 Euribor December 3 spread. This is created (with a credit of 440 to Sterling December 3 and a credit of 260 for Euribor December 3).

| | | | |
|---|---|---|---|
| Sterling December 2003 | +1 (260) | +1 (205) | Full UMR = 325 |
| Sterling March 2004 | | −1 (205) | Full UMR = 325 |
| Euribor December 2003 | −1 (440) | | Full UMR = 550 |

Assuming a −2 (short 2) active order is placed on Sterling December 3. The following describes the margin that is payable depending on how many of the active order fills.

| | | | No of Fills | | |
|---|---|---|---|---|---|
| | | | 0 | 1 | 2 |
| Sterling Dec 03 | +1 (260) | +1 (205) | 185 | 270 | 645 |
| Sterling Mar 04 | | −1 (205) | 120 | 120 | 120 |
| Euribor Dec 03 | −1 (440) | | 110 | 110 | 110 |
| Total Margin | | | 415 | 500 | 875 |

If there are 0 fills then the margin will be 415.

If there is 1 fill then the margin will be 500, 270 comes from the cost of breaking the cheapest spread (Sterling December 3 March 4). I would get 120 back on December 4 (325-205). However, I have to pay the cost of breaking March 4 (205). 185+205−120=270.

If there are 2 fills then the margin will be 645, 645 comes from the cost of breaking the more expensive spread as well (Sterling December 3 Euribor December 3). I would get 65 back on December 3 (325-260). However, I have to pay the cost of breaking Euribor (440). 270+440−65=645.

Therefore, the worst case the margin can be from placing a short 2 active position on the above portfolio will be 875. Note that in some cases, partially closing a spreaded position may actually reduce the margin payable. In many situations, the calculation is more complicated that the example illustrated here, but the same principles may be used (e.g. risk adding active positions may have to be factored in, worst case scenarios for potential future order placements may need to be analysed and “free” long or short margin calculated, the costs incurred in over closing may also need to be taken into account).

1. A system for managing risk in a trading environment, the system comprising at least one trading portfolio, wherein the trading portfolio comprises a plurality of trading elements and wherein the system further comprises:
means for obtaining data relating to trading elements in the trading environment;
means for calculating the value of a risk factor for the trading portfolio based on the data received for the trading elements in the trading portfolio;
means for receiving an order for the trading portfolio, wherein the order specifies a trading element; and
means for calculating an expected value of the risk factor for the trading portfolio based on the data received for the trading elements in the trading portfolio and the data received for the trading element specified in the order.

2. A system according to claim 1 wherein the expected value of the risk factor is calculated based on pre-stored information for use in calculating the risk factor, the pre-stored information being calculated and stored based on the risk factor prior to receipt of the order.

3. A system according to claim 1 further comprising means for storing data generated in calculating the value of the risk factor.

4. A system according to claim 3 wherein the expected value of the risk factor is calculated based further on the stored data.

5. A system according to claim 1, further comprising:
means for comparing the expected value of the risk factor to a predefined maximum value for the risk factor; and
means for placing the order in the trading environment if the expected value of the risk factor is lower than the predefined maximum value for the risk factor.

6. A system according to claim 1, further comprising:
means for comparing the expected value of the risk factor to a predefined maximum value for the risk factor; and
means for refusing the order if the expected value of the risk factor is higher than the predefined maximum value for the risk factor.

7. A system according to claim 1, wherein a first expected value of the risk factor is calculated and wherein the first expected value of the risk factor is compared to a predefined maximum value for the risk factor for the trading portfolio to determine whether the first expected value of the risk factor falls within a predefined range around the maximum value of the risk factor.

8. A system according to claim 7 wherein, if the first expected value of the risk factor falls outside the predefined range, the order is placed in the trading environment if the first expected value of the risk factor is lower than the maximum value of the risk factor.

9. A system according to claim 7 wherein, if the first expected value of the risk factor falls outside the predefined range, the order is refused if the first expected value of the risk factor is higher than the maximum value of the risk factor.

10. A system according to claim 1, wherein the expected value of the risk factor is based on at least one of: profit and loss data, margin, position, outright clip size and spread clip size.

11. A system according to claims 7, wherein, if the first expected value of the risk factor falls within a predefined range around the maximum value of the risk factor, at least one further expected value of the risk factor is calculated and wherein the order is placed or refused based on the at least one further expected value of the risk factor.

12. A system according to claim 11 wherein the at least one further expected value of the risk factor is calculated based on at least one step in the process of performing a SPAN calculation for the trading portfolio.

13. A system according to claim 1, wherein the value of the risk factor or the expected value of the risk factor is calculated based on performing a correlation between trading elements in the trading portfolio.

14. A system according to claim 13 wherein performing the correlation comprises performing correlation between different types of trading elements in the trading portfolio.

15. A system according to claim 13 wherein performing the correlation comprises a performing the correlation between two trading elements of the same type in the trading portfolio.

16. A system according to claim 13 wherein performing the correlation comprises obtaining a measure of volatility for at least one trading element.

17. A system according to claim 1, wherein the trading elements in the trading portfolio include existing filled and existing unfilled trading elements.

18. A system according to claim 17 wherein the risk factor is calculated based a worst case analysis of the unfilled trading elements.

19. A system according to claim 18 wherein the worst case analysis is performed based on at least one of:
the current sell value of each trading element;
the current buy value of each trading element;
the volatility of each trading element; and
a measure of the correlation between elements in the trading portfolio.

20. A system according to claim 19 wherein the volatility of each trading element is determined based on the volatility of the trading element during the preceding trading period.

21. A system according to claim 1, wherein the data received for the trading elements comprises at least one of:
profit and loss data;
margin;
position;
outright clip size; and
spread clip size.

22. A system according to claim 1, further comprising means for calculating SPAN data for the trading elements based on the data received for the trading elements.

23. A system according to claim 1 further comprising means for receiving SPAN data for the trading elements.

24. A system according to claim 1, wherein the value of the risk factor is calculated based on at least one of:
profit and loss data;
margin;
position;
outright clip size; and
spread clip size.

25. A system according to claim 1, wherein the value of the risk factor is calculated based on SPAN data for the trading elements.

26. A system according to claim 1, further comprising means for placing the order in the trading environment if the expected value of the risk factor is lower than the current value of the risk factor.

27. A system according to claim 1, wherein the value of the risk factor comprises a monetary value.

28. A system according to claim 1, wherein the value of the risk factor comprises a monetary value in the currency of the trading portfolio.

29. A system according to claim 1, wherein the value of the risk factor comprises a margin for the trading portfolio.

30. A system according to claim 29 wherein the margin comprises a clearing margin for the trading portfolio.

31. A system according to claim 1, wherein the data relating to the trading elements is received periodically or quasi-continuously.

32. A system according to claim 1, wherein the trading portfolio comprises a plurality of trading accounts, each trading account comprising at least one trading element.

33. A system according to claim 32 wherein the plurality of accounts comprise accounts associated with a single trader.

34. A system according to claim 1, wherein the value of the risk factor is recalculated at a regular predetermined interval.

35. A system according to claim 34 wherein the predetermined interval comprises around 5 minutes.

36. A system according to claim 34 wherein the predetermined interval comprises around 1 second.

37. A system according to claim 1, wherein the means for obtaining data comprises means for communicating with external trading systems to obtain values of trade parameters associated with the trading elements.

38. A system according to claim 37, wherein the trading parameters include at least one of:
the current sell value of the trading element;
the current buy value of the trading element;
the volatility of the trading element;
profit and loss data;
margin;
position;
outright clip size;
spread clip size; and
the current volume of the trading element in the market.

39. A system according to claim 1, wherein the trading elements comprise trading elements having types comprising at least one of:
shares;
commodities;
options;
futures; and
currencies.

40. A system according to claim 1, further comprising:
means for comparing the expected value of the risk factor to a predefined alert value for the risk factor; and
means for generating an alert message if the expected value of the risk factor is greater than the predefined alert value for the risk factor.

41. A system according to claim 40 wherein at least one of the predefined maximum value and the predefined alert value for the risk factor is defined by a portfolio administrator.

42. A system according to claim 1, further comprising a management interface, wherein an administrator can access information relating to the trading portfolio, and wherein the interface comprises at least one of means for:
placing orders in the trading environment for the trading portfolio;
setting maximum and alert values for the risk factor for the trading portfolio;
monitoring the trades performed within the trading portfolio;
monitoring the value of the risk factor for the trading portfolio;
refusing orders for the trading portfolio; and
receiving warning messages generated by the system in response to variations in the value of the risk factor.

43. A management interface for a system for managing risk in a trading environment, the system comprising a plurality of trading portfolios, wherein each trading portfolio comprises a plurality of trading elements and wherein the management interface comprises:
means for receiving data relating to each trading portfolio, the data including the value of a risk factor associated with each trading portfolio;
means for obtaining an expected value of the risk factor associated with a trading portfolio based on an order for a trading element submitted by the trading portfolio; and
means for displaying an alert signal if the expected value of the risk factor is greater than a predefined maximum value for the risk factor for the trading portfolio.

44. A management interface according to claim 43 further comprising means for setting the maximum value for the risk factor for one or more trading portfolios.

45. A management interface according to claim 43 further comprising means for setting an alert value for the risk factor for one or more trading portfolios.

46. A management interface according to claim 45 further comprising means for displaying an alert signal if the expected value of the risk factor for a trading portfolio is greater than the alert value for the trading portfolio.

47. A management interface according to claim 43 further comprising means for preventing a submitted order for a trading element from being placed in the trading environment.

48. A management interface according to claim 43 further comprising means for placing a submitted order for a trading element into the trading environment.

49. A management interface according to claim 43 further comprising means for displaying information associated with a plurality of trading portfolios.

50. A management interface according to claim 49 wherein the information associated with the trading portfolios comprises at least one of:
account name;
account balance;
profit and loss;
margin utilization;
net liquidity;
net equity; and
number of order rejections.

51. A management interface according to claim 43 further comprising means for placing an order into the trading environment for a selected trading portfolio.

52. A system for managing risk in a trading environment, the system comprising at least one trading portfolio, wherein the trading portfolio comprises a plurality of trading elements and wherein the system further comprises:
means for obtaining data relating to the trading elements in the trading portfolio;
means for calculating the value of a risk factor associated with the trading portfolio based on the data received;
means for periodically updating the risk factor associated with the trading portfolio; and
means for calculating an end of day position for a trading portfolio.

53. A system according to claim 52 further comprising means for closing a trading session on an exchange for a trading portfolio and means for supplying data relating to the end of day position for the trading portfolio.

54. A system according to claim 52 wherein the calculation of the value of the risk factor includes the value of the margin charged for each trading element.

55. A system according to claim 52, wherein the risk factor is calculated based on SPAN data for the trading elements.

56. A system according to claim 52, wherein the means for calculating the value of a risk factor comprises means for calculating a risk value for each trading element in the trading portfolio and means for combining the risk values for each trading element to form a risk factor for the trading portfolio.

57. A system according to claim 52, wherein the end of day position is calculated based on at least one of:
the profit and loss for the trading portfolio; and
the liquidity for the trading portfolio.

58. A system according to claim 52, further comprising means for receiving an order for a trading element on the exchange whilst closing the trading session, means for calculating an expected value for the risk factor incorporating the order for the trading element and means for accepting or rejecting the order for the trading element based on the expected value for the risk factor.

59. A system for calculating the value of a risk factor for a trading portfolio, the trading portfolio comprising a plurality of trading elements in a trading environment, the system comprising:
means for obtaining data relating to the trading elements in the trading environment;
means for calculating a first value of the risk factor for the trading portfolio based on the data received for the trading elements in the trading portfolio using at least one step in a predefined method for calculating the value of a risk factor;
means for comparing the first value of the risk factor to a predefined maximum value of the risk factor; and
means for caching the first value and the further values of the risk factor in a memory;
wherein if the first value of the risk factor is greater than the predefined maximum value of the risk factor and falls within a predefined range above the predefined maximum value of the risk factor the method further comprises a means for calculating at least one further value of the risk factor using further steps in a predefined method for calculating the value of a risk factor.

60. A system according to claim 59 wherein the predefined method for calculating the value of a risk factor comprises the SPAN method.

61. A system according to claim 59 wherein the trading portfolio comprises filled and unfilled orders.

62. A system according to claim 59, wherein the value of the risk factor is calculated based on a worst-case analysis of the unfilled orders.

63. A system according to claim 59, wherein the trading portfolio comprises at least one pre-trade order.

64. A system according to claims 59, wherein the value of the risk factor is used to determine whether the pre-trade order can be placed in the trading environment.

65. A method of calculating the value of a risk factor for a trading portfolio, the trading portfolio comprising a plurality of trading elements in a trading environment comprising filled and unfilled orders, the method comprising:
obtaining data relating to the trading elements in the trading environment;
calculating a first value of the risk factor for the trading portfolio based on the data received for the trading elements in the trading portfolio using at least one step in a predefined method for calculating the value of a risk factor;
comparing the first value of the risk factor to a predefined maximum value of the risk factor; and
caching the first value and the further values of the risk factor in a memory;
wherein if the first value of the risk factor is greater than the predefined maximum value of the risk factor and falls within a predefined range above the predefined maximum value of the risk factor, the method further comprises the step of calculating at least one further value of the risk factor using further steps in a predefined method for calculating the value of a risk factor.

66. A method for managing risk for at least one trading portfolio in a trading environment, wherein the trading portfolio comprises a plurality of trading elements and wherein the method comprises:
obtaining data relating to trading elements in the trading environment;
calculating the value of a risk factor for the trading portfolio based on the data received for the trading elements in the trading portfolio;
receiving an order for the trading portfolio, wherein the order specifies a trading element; and
calculating an expected value of the risk factor for the trading portfolio based on the data received for the trading elements in the trading portfolio and the data received for the trading element specified in the order.

67. A method of managing risk for at least one trading portfolio in a trading environment, wherein the trading portfolio comprises a plurality of trading elements and wherein the method comprises:
obtaining data relating to the trading elements in the trading portfolio;
calculating the value of a risk factor associated with the trading portfolio based on the data received; and
periodically updating the risk factor associated with the trading portfolio;
calculating an end of day position for a trading portfolio.

68. A computer program or computer program product configured to implement the method according to claim 65.

69. (canceled)

70. A computer program or computer program product configured to implement the method according to claim 66.

71. A computer program or computer program product configured to implement the method according to claim 67.
